(19) United States
(12) Patent Application Publication
(10) Pub. No.: US 2006/0198771 A1
(43) Pub. Date: Sep. 7, 2006

(54) Multilevel reactor, its uses, and process for manufacturing hydrogen peroxide

(76) Inventor: Michel Devic, Sainte Foy Les Lyon (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 11/403,655

(22) Filed: Apr. 13, 2006

Related U.S. Application Data
(62) Division of application No. 10/018,594, filed on Apr. 29, 2002, now abandoned.

(30) Foreign Application Priority Data
Jul. 16, 1999 (FR) 99/09260

(51) Int. Cl. B01J 19/00; B01J 19/18

(52) U.S. Cl. 422/224; 422/225

(57) ABSTRACT

This invention concerns a device comprising a cylindrical vertical stirred reactor (v), provided with centrifugal turbines (a) arranged along a single vertical agitated shaft, and its uses for implementing any process whereby several gas constituents are made to react in the presence of a solid suspended in a liquid phase. The device is particularly suited for directly making hydrogen peroxide.

This application is a divisional of application Ser. No. 10/018,594 filed Apr. 29, 2002.

### FIELD OF THE INVENTION

The present invention relates to a process in which gaseous components are reacted in the presence of a solid suspended in a liquid phase. The invention also relates to a device for implementing the process. More particularly, the invention relates to a device and a process for manufacturing hydrogen peroxide directly from oxygen and hydrogen, with a catalyst suspended in an aqueous phase.

### BACKGROUND OF THE INVENTION

Patent applications WO 96/05138 and WO 92/04277 disclose that hydrogen and oxygen can be reacted in a tubular reactor (pipeline reactor) in which there is high-speed circulation of an aqueous reaction medium comprising a suspended catalyst. Hydrogen and oxygen are thus dispersed in the reaction medium in proportions exceeding the limit for flammability of hydrogen, i.e. giving a molar concentration ratio of hydrogen to oxygen greater than 0.0416 (Enclopédie des Gaz [Gas Encyclopedia]—Air Liquide, page 909). A process of this type is safe only if hydrogen and oxygen remain in the form of small bubbles. Furthermore, to obtain a reasonable conversion of the gaseous reactants, the length of the tubular reactor has to be considerable and has to comprise a large number of bends. Under these conditions it is difficult to ensure that no gas pocket forms. In addition, any stoppage of the circulation of the aqueous reaction medium can cause an explosive continuous gaseous phase to appear.

European patent application EP 579 109 discloses that hydrogen and oxygen can be reacted in a “trickle bed” reactor filled with solid particles of catalyst through which the aqueous reaction medium and the gaseous phase containing hydrogen and oxygen can be made to flow cocurrently. Again, it is very difficult to ensure that a process of this type is safe, due to the risk that part of the trickle bed may dry out and to the difficulty of dissipating the considerable amounts of heat generated by the reaction.

The U.S. Pat. No. 4,009,252, U.S. Pat. No. 4,279,883, U.S. Pat. No. 4,681,751 and U.S. Pat. No. 4,772,458, furthermore, disclose a process for the direct manufacture of hydrogen peroxide, in which hydrogen and oxygen are reacted in a stirred reactor in the presence of a catalyst suspended in an aqueous reaction medium. However, the use of a stirred reactor has the disadvantage of leading to either a low conversion rate or inadequate productivity.

The literature generally indicates that complete operational safety requires that productivity be sacrificed, and that inversely an increase in productivity for hydrogen peroxide is obtained at the expense of safety.

### BRIEF DESCRIPTION OF THE DRAWINGS

FIG. 1 is a schematic of a reactor suitable for use in the present invention,

FIG. 2 is a cross section of a reactor suitable for use in the present invention.

FIG. 3 is a schematic of an alternate reactor suitable for use in the present invention.

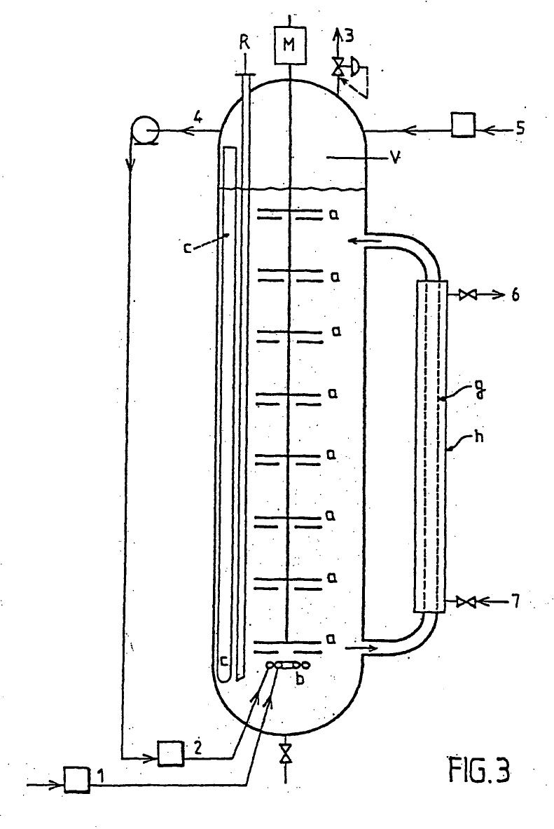

### DETAILED DESCRIPTION OF THE INVENTION

The subject of the present invention is therefore the provision of a process comprising a reaction step using gaseous components in the presence of a solid suspended in a liquid phase, and in particular a process for the direct manufacture of hydrogen peroxide in complete safety and with optimized productivity for hydrogen peroxide, and a device capable of implementing the same.

The device of the invention comprises a cylindrical vertical stirred reactor provided with means of injection of gaseous reactants at the bottom, with means of discharge at the top for removing the gaseous reactants, and with centrifugal turbines arranged, preferably regularly, along a single vertical agitating shaft. The vertical shaft is generally driven by a geared motor unit which is most often situated either above or below the reactor. Depending on the length of the shaft, it may be supported by one or more bearings.

The reactor may also be equipped with counter-baffles and/or with a heat exchanger.

The perfectly stirred reactor consists of a single space without any fixed horizontal partitions. The height of the reactor is generally between 1.5 and 10 times the diameter and preferably between 2 and 4 times the diameter. The reactor is also provided with a bottom and with a lid which can be flat or hemispherical.

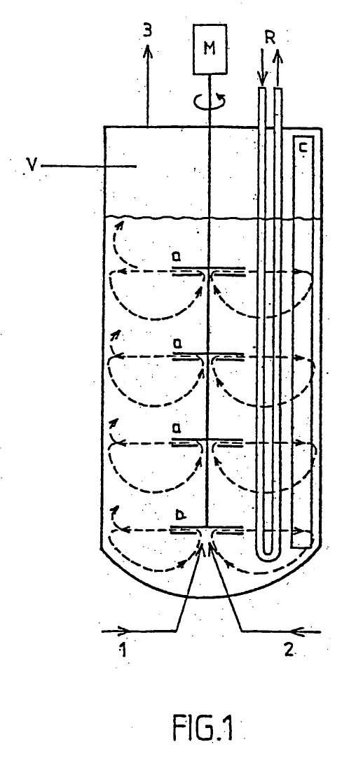

FIG. 1 is a simplified diagram of a particular device of the invention.

The device comprises a vertical stirred reactor (V) provided with centrifugal turbines (a) arranged along an agitating shaft driven by a motor (M). The reactor is also equipped with counter-baffles (c) and with a heat exchanger (R). Means of injection (1, 2) of gaseous reactants are provided at the bottom of the reactor, and a discharge (3) situated at the top of the reactor serves for evacuation of gaseous reactants.

Any type of centrifugal turbine capable of drawing a mixture of liquid, of bubbles of gas, and of suspended solid to the central axis of the reactor and of projecting this mixture radially in a horizontal plane in order to provide circulation of liquid mixture, bubbles of gas, and solid in accordance with FIG. 1 can be suitable according to the invention.

Preference is given to flanged radial turbines with one or two central openings. Flanged turbines similar to those used for centrifugal water pumps with the pumping orifice directed downward are very particularly suitable.

The turbines may be equipped with vanes arranged radially or at an angle or forming helices. The number of vanes is preferably between 3 and 24.

The number of turbines depends on the ratio of the height of the reactor to the diameter of the reactor and is generally between 2 and 20, preferably between 3 and 8.

The distance between two turbines is preferably between 0.5 and 1.5 times the external diameter of the turbine; this latter is preferably between 0.2 and 0.5 times the diameter of the reactor.

The thickness of the turbines is preferably between 0.07 and 0.25 times the diameter of the turbine. Thickness means the distance between the two flanges of the turbine.

The device according to the invention may also comprise a filter installed inside or outside the reactor.

In operation, the lower part of the reactor is occupied by a liquid phase comprising suspended solid catalysts and many small bubbles of gaseous reactants, while the upper part is occupied by a continuous gaseous phase. The volume occupied by the continuous gaseous phase represents between 10 and 30% of the total volume of the reactor and preferably between 20 and 25%.

The turbines are arranged along the agitating shaft so that they are immersed, and preferably completely immersed, in the liquid phase when agitation stops.

The speed of rotation of the turbine is chosen so as both to maximize the number of possible bubbles of gas per unit of volume of the liquid phase and minimize the diameter of the bubbles.

To prevent the entire liquid phase from rotating, the reactor is equipped with counter-baffles, preferably consisting of vertical rectangular plates arranged around the turbines. The counter-baffles are generally situated between the cylindrical wall of the reactor and the turbines.

The height of these metal plates is generally close to that of the cylindrical part of the reactor. The width is generally between 0.05 and 2 times the diameter of the reactor.

The number of counter-baffles selected is determined as a function of their width and is generally between 3 and 24 and preferably between 4 and 8.

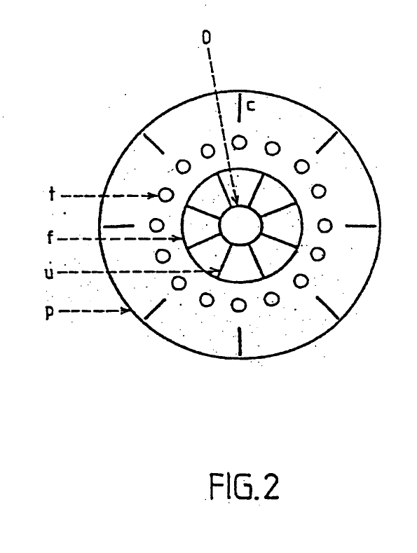

The counter-baffles (c) are preferably placed vertically at a distance of between 1 and 10 mm from the wall (p) of the reactor and oriented on the axis of radii coming from the center of the reactor, as shown in FIG. 2, which is a cross section of the reactor equipped with a particular turbine with (O) representing the suction orifice of the turbine, (f) the flange of the turbine, and (u) the vane of the turbine.

Some or all of the counter-baffles may be replaced by a heat exchanger. The exchanger preferably consists of a bundle of vertical cylindrical tubes whose height is close to or equal to that of the cylindrical part of the reactor.

These tubes (t) are generally arranged vertically around the turbines in accordance with FIG. 2.

The number and diameter of these tubes are determined in such a way as to maintain the temperature of the liquid phase within the desired limits. The number of tubes is often between 8 and 64.

Although the device according to the invention may be used for implementing a reaction at atmospheric pressure, it is most often preferable to operate under pressure. High pressures of the order of from 10 to 80 bar are advantageously selected to accelerate the reaction rate.

The reactor, the means of agitation, and the exchangers may consist of any material usual in the chemical industry, such as stainless steels (304 L or 316 L).

A protective coating of a polymer, such as PVDF (vinylidene polyfluoride), PTFE (polytetrafluoroethylene), PFA (copolymer of C₂F₄ and perfluorinated vinyl ether), or FEP (copolymer of C₂F₄ and C₃F₆) may be applied to all of the internal surfaces of the reactor, and external surfaces of the means of agitation and exchangers. It is also possible to restrict the coating to certain elements subject to abrasion, for example the turbines.

The device is very particularly suitable for the direct manufacture of hydrogen peroxide, with hydrogen and oxygen injected in the form of small bubbles of diameter lower than 3 mm and preferably between 0.5 and 2 mm, into the aqueous liquid phase, preferably with molar flow rates such that the ratio of molar flow rate of hydrogen to that of oxygen is greater than 0.0416, while the content of hydrogen in the continuous gaseous phase is maintained below the flammability limit.

The catalysts generally used are those described in U.S. Pat. No. 4,772,458. These are solid catalysts based on palladium and/or platinum, optionally supported on silica, alumina, carbon, or aluminosilicates.

Besides suspended catalysts, the aqueous phase, acidified by addition of a mineral acid, may comprise stabilizers for hydrogen peroxide and decomposition inhibitors, for example halides. Bromide is particularly preferred and is advantageously used in combination with free bromine (Br₂).

The invention also provides the process comprising a reaction step using gaseous components in the presence of a solid suspended in a liquid phase. This process consists in introducing the gaseous components (2 or more) at the bottom of the reactor either separately or in the form of a mixture. Introduction in the form of a mixture is preferred when the composition of the gaseous mixture is compatible with safety requirements. In this case the feeding of reactants may take place by way of a duct housed in the agitating shaft and then by way of a set of small orifices in the center of the turbine situated at the bottom of the reactor, in such a way as to produce a large number of small bubbles in the liquid flux ejected by the turbine.

When the process requires feeding of the gaseous components in proportions which create risk of fire or of explosion, the gaseous reactants are introduced separately into the reactor either by injection by way of discrete pipes situated upstream of the lowest suction orifice of the turbine, or by way of discrete fritted tubes situated immediately below the lowest turbine.

The device of the present invention may operate continuously or semicontinuously.

In semicontinuous mode, the gaseous reactants are introduced continuously during a defined time into the lower part of the reactor, occupied by a liquid phase comprising the suspended solid catalyst.

Excess gaseous reactants reaching the continuous gaseous phase of the reactor are generally evacuated continuously by maintaining a constant prevailing pressure inside the reactor. At the end of the defined time, the reactor is discharged to recover the products of the reaction.

When operation is continuous, the gaseous reactants and the reaction solution are introduced continuously into the reactor, initially charged with solid catalyst suspended in the reaction solution constituting the liquid phase. Excess gaseous reactants are evacuated continuously, and the products of the reaction are continuously decanted by way of continuous withdrawal of the liquid phase through one or more filters in such a way as to keep the solid catalysts suspended inside the reactor.

The filter(s) may be of candle-filter type made of fritted metal or of ceramic material, the filters preferably being placed vertically in the reactor alongside the vertical cooling tubes or the counter-baffles.

The filters may also be placed outside the reactor and in this case preferably consist of a hollow porous tube, made of metal or of ceramic material, inside which the liquid phase from the reactor, comprising the suspended catalyst, circulates in a closed circuit. A device comprising a filter outside the reactor is illustrated by figure No. 3. The hollow tube (g) is arranged vertically and is fed at its base with the liquid phase withdrawn at the bottom of the reactor, and the liquid phase collected at the top of the tube is returned to the upper part of the reactor. This continuous circulation may be brought about by a pump or else by local pressure increases created by the agitating turbines of the reactor.

In accordance with a preferred device of the invention, represented in figure No. 3, the clear liquid phase after removal of catalyst is collected in a jacket (h) placed around the porous hollow tube, and then evacuated by way of a control valve (6) in such a way as to maintain a constant level of liquid phase in the reactor. Reaction solution is continuously pumped into the reactor with a flow rate calculated to maintain a chosen value for the concentration of the product of the reaction, soluble in the liquid phase. Some of the reaction solution may advantageously be injected progressively into the jacket (h) by way of the duct 7, to unblock the filter. The reaction solution may also be sprayed at high pressure for a continuous cleaning of the continuous gaseous phase in the reactor.

The gaseous reactants are introduced continuously into the bottom (b) of the reactor by way of routes 1 and 2, and those which have not reacted may be recycled by way of route 4.

In the case of direct synthesis of hydrogen peroxide, a selected flow rate of hydrogen is injected via (1) into the liquid phase, below the bottom turbine (b). A selected flow rate of oxygen comprising a low proportion of hydrogen is withdrawn (4) into the continuous gaseous phase in the reactor and injected into the liquid phase via (2), below the bottom turbine (b). A flow rate of fresh oxygen (5) is injected into the continuous gas phase in the reactor to compensate for the oxygen consumed and also to keep the continuous gaseous phase outside flammability limits. A pressure regulator (release valve) allows excess gaseous reactants (3) and inert gases which are possibly present in the fresh oxygen, for example nitrogen, to be evacuated from the continuous gaseous phase in the reactor.

An advantage of the device of the invention in the event that stirring stops accidentally is that it allows all of the bubbles of the gaseous reactants to rise and directly arrive at the continuous gaseous phase solely under the action of gravitational forces.

### EXPERIMENTAL SECTION (EXAMPLES)

Device for the Direct Synthesis of an Aqueous Solution of Hydrogen Peroxide

The reactor, of capacity 1 500 cm³, consists of a cylindrical vessel 200 mm in height and 98 mm in diameter.

The bottom and the lid are flat.

A removable PTFE sleeve of thickness 1.5 mm is placed into the interior of the reactor.

Agitation is provided by a vertical stainless steel axle of length 180 mm and of diameter 8 mm, driven by a magnetic coupling placed on the lid of the reactor.

One, two or three flanged turbines of external diameter 45 mm, thickness 9 mm (between the two flanges) provided with a suction orifice of diameter 12.7 mm, oriented downward, and with 8 flat radial vanes of width 9 mm, length 15 mm, and thickness 1.5 mm may be fixed to the agitating shaft at various selected heights in such a way as to divide the liquid phase into substantially equal volume.

The bottom turbine is placed 32 mm from the bottom, the second turbine 78 mm from the bottom, and the third 125 mm from the bottom.

Four counter-baffles of height 190 mm, width 10 mm, and thickness 1 mm, are placed vertically in the vessel, perpendicularly to the inner wall of the reactor, and held 1 mm from this wall by two centering rings.

The cooling or heating is provided by eight vertical tubes of diameter 6.35 mm and length 150 mm, arranged in a ring 35 mm from the axis of the vessel.

A stream of water at a constant temperature flows through this coil.

Hydrogen and oxygen are injected into the liquid phase by means of two discrete stainless pipes of diameter 1.58 mm, conducting the gases to the center of the bottom turbine. The injection of the gaseous reactants into the aqueous medium, and that of the oxygen into the continuous gaseous phase, are controlled with the aid of mass flow meters. In certain experiments carried out, oxygen was replaced by a mixture of oxygen and nitrogen in various proportions.

The pressure prevailing inside the reactor is kept constant by a release valve.

In-line gas-phase chromatography is used to determine the amounts of hydrogen, oxygen, and optionally nitrogen constituting the gaseous flux being discharged from the reactor.

Catalyst Preparation

The catalyst used comprises 0.7% by weight of palladium metal and 0.03% by weight of platinum supported on microporous silica.

It is prepared by impregnating the silica (Aldrich Ref. 28,851-9) with the following characteristics:

| | |
|---|---|
| Average particle size = | from 5 to 15 μm |
| BET surface area = | 500 m²/g |
| Pore volume = | 0.75 cm³/g |
| Average pore diameter = | 60 Å |

with an aqueous solution comprising PdCl₂ and H₂PtCl₆, and then drying, and finally heat treatment under hydrogen at 300° C. for 3 hours.

The catalyst is then suspended (10 g/l) in a solution comprising 60 mg of NaBr, 5 mg of Br₂ and 12 g of H₃PO₄, the solution being heated at 40° C. for 5 hours, and the catalyst is then filtered, washed with demineralized water, and dried.

Aqueous Reaction Medium

An aqueous solution is prepared by adding 12 g of H₃PO_{4, 58} mg of NaBr, and 5 mg of Br₂ to 1 000 cm³ of demineralized water.

General Operating Specification

The selected volume of aqueous reaction medium is introduced into the autoclave, and then the calculated quantity of catalyst is added. The autoclave is pressurized by injecting oxygen at a selected flow rate into the continuous gaseous phase. The pressure remains constant due to the pressure regulator. The liquid medium is brought to the selected temperature by circulating temperature-controlled water within the bundle of cooling tubes.

The agitation is controlled to 1 900 rpm, and oxygen and hydrogen are injected at the selected flow rates to the center of the bottom turbine.

The flow rate of, and the hydrogen content in, the gaseous mixture coming out of the pressure regulator are measured.

After 1 hour of reaction, the inflow of hydrogen and oxygen into the aqueous reaction medium is shut down, and the injection of oxygen into the continuous gaseous phase is maintained until all of the hydrogen in this latter has disappeared. The inflow of oxygen is then shut down, and the reactor is then depressurized, and finally the aqueous solution of hydrogen peroxide is recovered.

Once recovered, the aqueous solution of hydrogen peroxide is weighed, and then separated from the catalyst by filtration over a Millipore® filter.

The resultant solution is then subjected to iodometric analysis, which allows the concentration of hydrogen peroxide to be calculated. The selectivity of the synthesis is defined as the percentage obtained when the number of moles of hydrogen peroxide formed is divided by the number of moles of hydrogen consumed.

The conversion rate is defined as the percentage obtained when the volume of hydrogen consumed is divided by the volume of hydrogen introduced.

The conditions of operation and the results obtained during the various experiments are presented in the table below.

For examples 2, 3, 7, 8, 9 and 14 operations are carried out with the two bottom turbines.

TABLE
(for 1 hour of reaction)

| | | | | | | Flow | | | | | | | |
|---|---|---|---|---|---|---|---|---|---|---|---|---|---|
| | | | | Flow | Flow | rate of | Flow | | | Concentration | | | |
| | | | | rate of | rate of | N₂ | rate of | | | of H₂ in | Concen- | | |
| | | | | H₂ | O₂ | injected | O₂ injected | | | the | tration | | |
| | | | Initial | injected | injected | with O₂ | into | | Tem- | continous | of H₂O₂ | | Reaction |
| | Number | | volume | into | into | into | the | | pera- | gaseous | in the | | selectivity |
| | of | Amount | of | the | the | the | continuous | Pressure | ture | phase | aqueous | Hydrogen | based |
| Ex- | turbine | of | aqueous | bottom | bottom | bottom | gaseous | in the | in the | in the | solution | conversion | on |
| am- | in | catalyst | solution | turbine | turbine | turbine | phase | reactor | reactor | reactor | obtained | rate | hydrogen |
| ple | reactor | (g) | (cm³) | (Nl/h) | (Nl/h) | (Nl/h) | (Nl/h) | (bar) | (° C.) | (%) | (%) | (%) | (%) |
| 1 | 1 | 6 | 430 | 120 | 240 | 0 | 2640 | 50 | 40 | 2.5 | 12.5 | 36 | 91 |
| 2 | 2 | 6 | 700 | 120 | 240 | 0 | 2640 | 50 | 41 | 1.4 | 12.2 | 60 | 90 |
| 3 | 2 | 9 | 700 | 120 | 240 | 0 | 2640 | 50 | 41 | 1.4 | 12.2 | 60.8 | 89 |
| 4 | 3 | 8.5 | 1000 | 120 | 240 | 0 | 2640 | 50 | 40 | 0.95 | 10.6 | 73 | 90 |
| 5 | 3 | 8.5 | 1000 | 120 | 240 | 0 | 2640 | 60 | 40 | 0.87 | 10.8 | 76 | 89 |
| 6 | 3 | 8.5 | 1000 | 120 | 240 | 0 | 2640 | 60 | 60 | 0.5 | 11.0 | 82 | 84 |
| 7 | 2 | 6 | 700 | 25 | 335 | 0 | 265 | 50 | 39 | 2.1 | 2.3 | 45 | 97 |
| 8 | 2 | 6 | 700 | 80 | 280 | 0 | 1640 | 50 | 40 | 1.8 | 8.1 | 53 | 96 |
| 9 | 2 | 6 | 700 | 100 | 260 | 0 | 2140 | 50 | 40 | 1.6 | 10.2 | 57 | 92 |
| 10 | 3 | 8.5 | 1000 | 120 | 216 | 24 | 2640 | 50 | 40 | 0.95 | 10.5 | 73 | 89 |
| 11 | 3 | 8.5 | 1000 | 120 | 240 | 60 | 2580 | 50 | 40 | 1.13 | 10.0 | 68 | 90 |
| 12 | 3 | 8.5 | 1000 | 120 | 120 | 480 | 1980 | 50 | 40 | 1.83 | 6.3 | 55 | 70 |
| 13 | 3 | 8.5 | 1000 | 100 | 130 | 520 | 1400 | 50 | 40 | 2.07 | 5.7 | 50.4 | 80 |
| 14 | 2 | 6 | 700 | 140 | 220 | 0 | 3140 | 50 | 40 | 1.43 | 13.8 | 61 | 87 |
| 15 | 3 | 8.5 | 1000 | 140 | 220 | 0 | 3140 | 50 | 40 | 0.82 | 12.2 | 74 | 89 |

Examples 1, 2, 3 and 4 show, for identical conditions of temperature, pressure, and H₂/O₂ ratio, that increasing the number of radial turbines allows the conversion rate to be increased just as efficiently as by combining a number of reactors in a cascade.

This is because, if τ₁ denotes the conversion rate of one level (reactor with 1 turbine), τ₂ denotes the overall conversion rate of the reactor with 2 turbines, and τ₃ denotes the conversion rate of the reactor with 3 turbines, the rule for calculating conversion in stirred reactors installed in a cascade is indeed found to apply:
(1−τ₂)=(1−τ₁)(1−τ₁) and
(1−τ₃)=(1−τ₁)(1−τ₁)(1−τ₁)

Using this relationship it is possible to extrapolate the number of turbines necessary to obtain the high conversion rate sought by the invention.

Examples 7, 8 and 9 show, for one reactor and identical reaction conditions, that the conversion rate and the content of H₂O₂ in the solution after 1 hour of reaction increases markedly with the concentration of hydrogen in the gaseous mixture introduced into the liquid phase.

Examples 5 and 6 show that it is possible with the reactor according to the invention to obtain a conversion rate of 80% with only 3 turbines, with productivity exceeding 100 kg of H₂O₂ per hour and per useful m³ in a reactor, with very high selectivity.

Examples 10 and 11 show that using the reactor according to the invention it is possible to obtain high conversion rates and concentrations of H₂O₂ if use is made of a mixture of oxygen and nitrogen (from 10% to 20%) instead of pure oxygen.

The use of air (example 12 and 13) again gives interesting results.

Examples 14 and 15 also show, with a different H₂/O₂ ratio, that moving from 2 turbines to 3 turbines allows the hydrogen conversion rate to be increased and the concentration of H₂ to be reduced in the continuous gaseous phase in the reactor.

1-14. (canceled)

15. A process of reacting at least two gaseous reactants in the presence of a solid catalyst suspended in a liquid phase, which comprises injecting said gaseous reactants at the bottom of a cylindrical vertical reactor, having a bottom and a top, stirring the gaseous reactants in the liquid phase containing the solid suspended catalyst with a plurality of centrifugal turbines arranged along a vertical agitating shaft oriented on the central axis of said vertical reactor and discharging a gaseous reaction product from the top of said reactor.

16. A process for preparing an aqueous solution of hydrogen peroxide starting from hydrogen and from oxygen, comprising injecting hydrogen and oxygen into the bottom of a cylindrical vertical reactor having a bottom and a top, containing a liquid phase containing a solid suspended catalyst stirring said hydrogen and oxygen in said liquid phase containing a solid suspended catalyst with a plurality of centrifugal turbines arranged along a vertical agitating shaft oriented on the central axis of said vertical reactor.

17. The process of claim 15, wherein the centrifugal turbines are arranged regularly along a single vertical shaft.

18. The process of claim 15, wherein the reactor further comprises counter-baffles.

19. The process of claim 15, wherein the reactor further comprises a heat exchanger.

20. The process of claim 15, wherein the height of the reactor is between about 1.5 and about 10 times the diameter of the reactor.

21. The process of claim 15, wherein the height of the reactor is between about 2 and 4 times the diameter.

22. The process of claim 15, wherein the turbines are radial.

23. The process of claim 15, wherein the turbines are flanged.

24. The process of claim 15, wherein the turbines have one or more central opening.

25. The process of claim 15, wherein the number of the turbines is between 2 and 20.

26. The process of claim 15, wherein the number of the turbines is between 3 and 8.

27. The process of claim 15, wherein the diameter of the turbines is between about 0.2 to about 0.5 times the diameter of the reactor.

28. The process of claim 15, wherein the diameter of the turbines is between about 0.07 to about 0.25 times the diameter of the reactor.

29. The process of claim 16, the turbines comprise vanes, which the vanes are arranged in helix, at an angle or in radial.

30. The process of claim 16, wherein the centrifugal turbines are arranged regularly along a single vertical shaft.

31. The process of claim 16, wherein the reactor further comprises counter-baffles.

32. The process of claim 16, wherein the reactor further comprises a heat exchanger.

33. The process of claim 16, wherein the height of the reactor is between about 1.5 and about 10 times the diameter of the reactor.

34. The process of claim 16, wherein the height of the reactor is between about 2 and 4 times the diameter.

35. The process of claim 16, wherein the turbines are radial.

36. The process of claim 16, wherein the turbines are flanged.

37. The process of claim 16, wherein the turbines have one or more central opening.

38. The process of claim 16, wherein the number of the turbines is between 2 and 20.

39. The process of claim 16, wherein the number of the turbines is between 3 and 8.

40. The process of claim 16, wherein the diameter of the turbines is between about 0.2 to about 0.5 times the diameter of the reactor.

41. The process of claim 16, wherein the diameter of the turbines is between about 0.07 to about 0.25 times the diameter of the reactor.

42. The process of claim 16, the turbines comprise vanes, which the vanes are arranged in helix, at an angle or in radial.
